(19) United States
(12) Patent Application Publication
(10) Pub. No.: US 2024/0406364 A1
(43) Pub. Date: Dec. 5, 2024

(54) Recording Content in a Head-mounted Device

(71) Applicant: Apple Inc., Cupertino, CA (US)

(72) Inventors: Maneli Noorkami, Menlo Park, CA (US); Afshin Taghavi Nasrabadi, Los Gatos, CA (US); Alexander P. Yu, Mountain View, CA (US); Michael A. Glass, Nyack, NY (US); Travis W. Brown, Boulder, CO (US)

(21) Appl. No.: 18/644,222

(22) Filed: Apr. 24, 2024

Related U.S. Application Data
(60) Provisional application No. 63/505,776, filed on Jun. 2, 2023.

(51) Int. Cl. H04N 13/189; H04N 13/156; H04N 13/178; H04N 13/366

(52) U.S. Cl. CPC H04N 13/189; H04N 13/156; H04N 13/178; H04N 13/366

(57) ABSTRACT

A head-mounted device is provided that includes a variety of subsystems for generating extended reality content, displaying the extended reality content, and recording the extended reality content. The device may include a graphics rendering pipeline configured to render virtual content, tracking sensors configured to obtain user tracking information, a virtual content compositor configured to composite virtual frames based on the virtual content and the user tracking information, cameras configured to capture a video feed, a media merging compositor configured to overlay the composited virtual frames and the video feed, and a recording pipeline configured to record parameters, metadata, raw content, and/or adjusted content in an extended reality recording file. The extended reality recording file may have multiple discrete portions that may each be individually edited. The extended reality recording file may be used to present a replay on the head-mounted device and/or may be exported to an external device.

This application claims the benefit of U.S. provisional patent application No. 63/505,776, filed Jun. 2, 2023, which is hereby incorporated by reference herein in its entirety.

### FIELD

This relates generally to electronic devices, and, more particularly, to electronic devices such as head-mounted devices.

### BACKGROUND

Electronic devices such as head-mounted devices can include hardware and software subsystems for performing gaze tracking, hands tracking, and head pose tracking on a user. Such an electronic device can also include a graphics rendering module for generating virtual content that is presented on a display of the electronic device. Prior to display, the virtual content may be adjusted based on the user tracking information. The adjusted virtual content can then be output on the display to the user.

The content that is displayed to the user may be recorded. However, if care is not taken, the recorded content may have artifacts when displayed on other electronic devices.

### SUMMARY

A method of operating an electronic device to display a mixed reality scene may include capturing video frames with at least one image sensor, rendering virtual content, displaying the mixed reality scene by generating display frames based on the captured video frames, the rendered virtual content, and at least one parameter, and generating a recording of the mixed reality scene comprised of a first track including the captured video frames, a second track including the rendered virtual content, and metadata including the at least one parameter.

A method of operating an electronic device may include receiving recorded data for an extended reality session that includes a video feed, virtual content, and a parameter used to adjust at least one of the video feed and the virtual content, editing the parameter, and presenting a replay of the extended reality session using the edited parameter, the video feed, and the virtual content.

A method of operating an electronic device may include capturing a video feed with one or more cameras, generating virtual content with a graphics rendering pipeline, presenting an extended reality session using the video feed and the virtual content while using a first value for a parameter that adjusts at least one of the video feed and the virtual content, saving data for the extended reality session including the video feed and the virtual content, and replaying the extended reality session using the data saved for the extended reality environment while using a second value for the parameter that is different than the first value.

### BRIEF DESCRIPTION OF THE DRAWINGS

FIG. 1 is a top view of an illustrative head-mounted device in accordance with some embodiments.

FIG. 2 is a schematic diagram of an illustrative head-mounted device in accordance with some embodiments.

FIG. 3 is a diagram showing illustrative display and recording pipelines within a head-mounted device in accordance with some embodiments.

FIG. 4 is a diagram of an illustrative extended reality recording file in accordance with some embodiments.

FIG. 5A is a view of an illustrative display during a real time extended reality session in accordance with some embodiments.

FIG. 5B is a view of an illustrative display during an edited replay of the extended reality session of FIG. 5A in accordance with some embodiments.

FIG. 5C is a diagram of an illustrative extended reality recording file associated with the extended reality session of FIGS. 5A and 5B in accordance with some embodiments.

FIG. 6 is a diagram showing an illustrative system with an electronic device that receives an extended reality recording file from a head-mounted device in accordance with some embodiments.

FIG. 7 is a flowchart of an illustrative method for operating a head-mounted device that saves extended reality recording files in accordance with some embodiments.

FIG. 8 is a flowchart of an illustrative method for operating an electronic device that receives an extended reality recording file from an additional device in accordance with some embodiments.

FIG. 9 is a flowchart of an illustrative method for operating a head-mounted device that presents a replay of an extended reality session based on an extended reality recording file in accordance with some embodiments.

### DETAILED DESCRIPTION

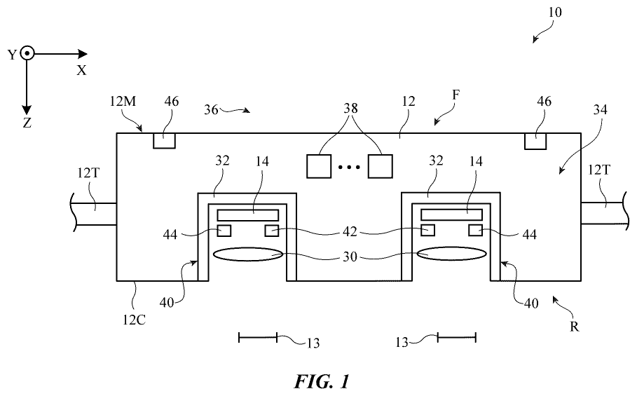

A top view of an illustrative head-mounted device is shown in FIG. 1. As shown in FIG. 1, head-mounted devices such as electronic device 10 may have head-mounted support structures such as housing 12. Housing 12 may include portions (e.g., head-mounted support structures 12T) to allow device 10 to be worn on a user's head. Support structures 12T may be formed from fabric, polymer, metal, and/or other material. Support structures 12T may form a strap or other head-mounted support structures to help support device 10 on a user's head. A main support structure (e.g., a head-mounted housing such as main housing portion 12M) of housing 12 may support electronic components such as displays 14.

Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures, and these rigid walls may optionally be covered with electrical components, fabric, leather, or other soft materials, etc. Housing portion 12M may also have internal support structures such as a frame (chassis) and/or structures that perform multiple functions such as controlling airflow and dissipating heat while providing structural support.

The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, spectacles, a hat, a mask, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have one or more cameras such as cameras 46 of FIG. 1. Cameras 46 that are mounted on front face F and that face outwardly (towards the front of device 10 and away from the user) may sometimes be referred to herein as forward-facing or front-facing cameras. Cameras 46 may capture visual odometry information, image information that is processed to locate objects in the user's field of view (e.g., so that virtual content may be registered appropriately relative to real-world objects), image content that is displayed in real time for a user of device 10, and/or other suitable image data. For example, forward-facing (front-facing) cameras may allow device 10 to monitor movement of the device 10 relative to the environment surrounding device 10 (e.g., the cameras may be used in forming a visual odometry system or part of a visual inertial odometry system). Forward-facing cameras may also be used to capture images of the environment that are displayed to a user of the device 10. If desired, images from multiple forward-facing cameras may be merged with each other and/or forward-facing camera content may be merged with computer-generated content for a user.

Device 10 may have any suitable number of cameras 46. For example, device 10 may have K cameras, where the value of K is at least one, at least two, at least four, at least six, at least eight, at least ten, at least 12, less than 20, less than 14, less than 12, less than 10, 4-10, or other suitable value. Cameras 46 may be sensitive at infrared wavelengths (e.g., cameras 46 may be infrared cameras), may be sensitive at visible wavelengths (e.g., cameras 46 may be visible cameras), and/or cameras 46 may be sensitive at other wavelengths. If desired, cameras 46 may be sensitive at both visible and infrared wavelengths.

Device 10 may have left and right optical modules 40. Optical modules 40 support electrical and optical components such as light-emitting components and lenses and may therefore sometimes be referred to as optical assemblies, optical systems, optical component support structures, lens and display support structures, electrical component support structures, or housing structures. Each optical module may include a respective display 14, lens 30, and support structure such as support structure 32. Support structure 32, which may sometimes be referred to as a lens support structure, optical component support structure, optical module support structure, or optical module portion, or lens barrel, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, waveguides, and/or other display components for producing images.

Lenses 30 may include one or more lens elements for providing image light from displays 14 to respective eyes boxes 13. Lenses may be implemented using refractive glass lens elements, using mirror lens structures (catadioptric lenses), using Fresnel lenses, using holographic lenses, and/or using other lens systems.

When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution should be locally enhanced in a foveated imaging system. To ensure that device 10 may capture satisfactory eye images while a user's eyes are located in eye boxes 13, each optical module 40 may be provided with a camera such as camera 42 and one or more light sources such as light-emitting diodes 44 or other light-emitting devices such as lasers, lamps, etc. Cameras 42 and light-emitting diodes 44 may operate at any suitable wavelengths (visible, infrared, and/or ultraviolet). As an example, diodes 44 may emit infrared light that is invisible (or nearly invisible) to the user. This allows eye monitoring operations to be performed continuously without interfering with the user's ability to view images on displays 14.

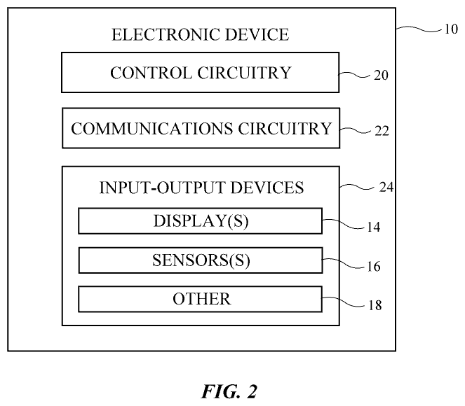

A schematic diagram of an illustrative electronic device such as a head-mounted device or other wearable device is shown in FIG. 2. Device 10 of FIG. 2 may be operated as a stand-alone device and/or the resources of device 10 may be used to communicate with external electronic equipment. As an example, communications circuitry 22 in device 10 may be used to transmit user input information, sensor information, and/or other information to external electronic devices (e.g., wirelessly or via wired connections). Each of these external devices may include components of the type shown by device 10 of FIG. 2.

As shown in FIG. 2, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. One or more processors in control circuitry 20 may be used to gather input from sensors and other input devices and may be used to control output devices. The processing circuitry may be based on one or more processors such as microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output. Control circuitry 20 may be configured to perform operations in device 10 using hardware (e.g., dedicated hardware or circuitry), firmware, and/or software. Software code for performing operations in device 10 may be stored on storage circuitry (e.g., non-transitory (tangible) computer readable storage media that stores the software code). The software code may sometimes be referred to as program instructions, software, data, instructions, or code. The stored software code may be executed by the processing circuitry within circuitry 20.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device or a controller, computer stylus, or other input device, speakers or other output devices, etc.) over a wireless link.

For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), displays including waveguides, and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors (e.g., cameras), fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion of device 10 and/or information about a pose of a user's head (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, three-dimensional camera systems such as depth sensors (e.g., structured light sensors and/or depth sensors based on stereo imaging devices that capture three-dimensional images) and/or optical sensors such as self-mixing sensors and light detection and ranging (lidar) sensors that gather time-of-flight measurements (e.g., time-of-flight cameras), humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays may be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

Display(s) 14 may be used to present a variety of content to a user's eye. The left and right displays 14 that are used to present a fused stereoscopic image to the user's eyes when viewed through eye boxes 13 may sometimes be referred to collectively as a display 14. As an example, real-world content may be presented by display 14. “Real-world” content may refer to images of a physical environment being captured by one or more front-facing cameras (see, e.g., cameras 46 in FIG. 1) and passed through as a live feed to the user. The real-world content being captured by the front-facing cameras is therefore sometimes referred to as a camera passthrough feed, a (live) video passthrough feed, or a passthrough video feed (stream).

A physical environment refers to a physical world that people can sense and/or interact with without the aid of an electronic device. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. In some embodiments, display 14 can be used to output extended reality (XR) content, which can include virtual reality content, augmented reality content, and/or mixed reality content.

It may be desirable to record a user's experience in an XR environment. Consider an example where a first person is using a head-mounted device for an XR experience (sometimes referred to as an XR session). The XR session of the first person may be recorded. The recording may be shared (in real time or after the XR session is complete) with a second person (e.g., via an additional electronic device that presents the recording of the XR session to the second person) or subsequently replayed by the first person. Recording the XR session therefore allows for a more social experience (by sharing the XR session with others), enables additional functionality, etc.

A user may view a replay of an XR environment on a head-mounted device that is the same or similar to the head-mounted device that originally produced the XR environment. In other situations, a user may view a replay of an XR environment on a different type of device such as a cellular telephone, laptop computer, tablet computer, etc. The device presenting a replay of an XR environment may have a non-stereoscopic display. If care is not taken, the replay of the XR environment may have artifacts when presented on the non-stereoscopic display.

In addition to viewing replays of an XR environment, it may be desirable to edit replays of an XR environment. Editing replays of the XR environment may allow for desired modifications to be made to the replay (e.g., for presentation on different types of devices, to change an aesthetic quality of the replay, etc.). However, if care is not taken it may be difficult to edit a replay of an XR environment in a desired manner.

To improve flexibility when editing a recording of an XR environment, a file storing the recording may have a plurality of elements (sometimes referred to subsets, portions, plates, or tracks). During presentation of the XR environment using head-mounted device 10, the plurality of different elements may be used to present a unitary XR environment. However, each element may be stored individually in the XR recording. Subsequently, each element may be individually edited without impacting the other recorded elements. After editing, the plurality of elements in the recording may be used to present the recording of the XR environment (e.g., using the same device on which the recording was generated or using a different device than on which the recording was generated).

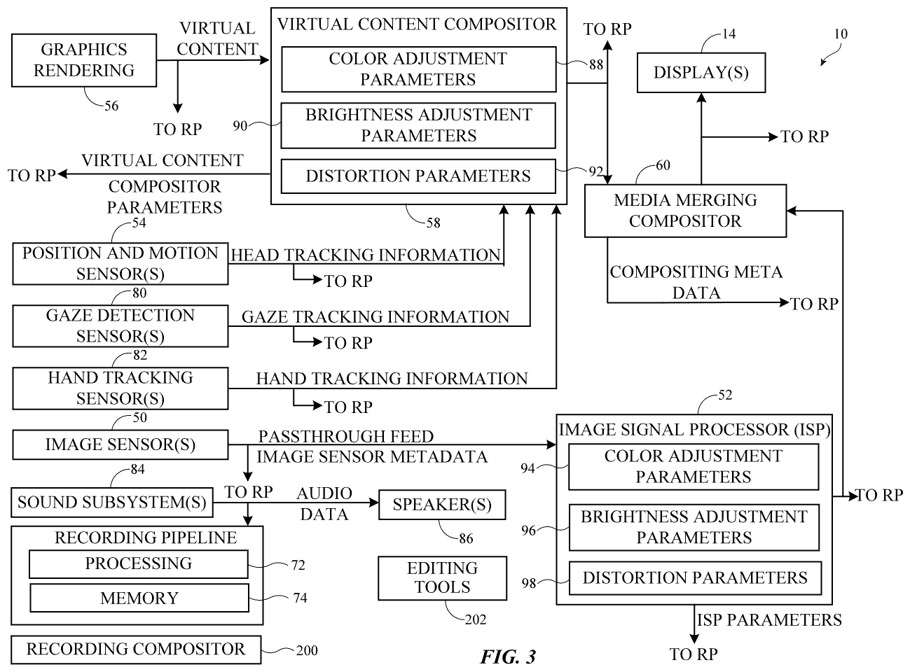

FIG. 3 is a diagram showing various hardware and software subsystems that may be included within device 10. As shown in FIG. 3, device 10 may include a graphics rendering subsystem such as graphics rendering pipeline 56, user tracking subsystems including one or more position and motion sensors(s) 54, one or more gaze detection sensors 80, and one or more hand tracking sensor(s) 82, imaging subsystems including one or more image sensor(s) 50, an image signal processing subsystem such as image signal processor (ISP) 52, a virtual content compositing subsystem such as virtual content compositor 58, a media merging subsystem such as media merging compositor 60, one or more sound generating subsystem(s) such as sound subsystem 84, and one or more speakers 86.

Graphics rendering pipeline 56, sometimes referred to as a graphics rendering engine or graphics renderer, may be configured to render or generate virtual content (e.g., virtual reality content, augmented reality content, mixed reality content, and/or extended reality content) or may be used to carry out other graphics processing functions. The virtual content output from the graphics rendering pipeline may optionally be foveated (e.g., subsystem 56 may render foveated virtual content). Graphics rendering pipeline 56 may synthesize photorealistic or non-photorealistic images from one or more 2-dimensional or 3-dimensional model(s) defined in a scene file that contains information on how to simulate a variety of features such as information on shading (e.g., how color and brightness of a surface varies with lighting), shadows (e.g., how to cast shadows across an object), texture mapping (e.g., how to apply detail to surfaces), reflection, transparency or opacity (e.g., how light is transmitted through a solid object), translucency (e.g., how light is scattered through a solid object), refraction and diffraction, depth of field (e.g., how certain objects may appear out of focus when outside the depth of view), motion blur (e.g., how certain objects may appear blurry due to fast motion), and/or other visible features relating to the lighting or physical characteristics of objects in a scene. Graphics renderer 56 may apply rendering algorithms such as rasterization, ray casting, ray tracing, radiosity, or other graphics processing algorithms.

Position and motion sensors 54 may include accelerometers, magnetic sensors such as compass sensors, gyroscopes, and/or inertial measurement units that contain some or all of these sensors. Position and motion sensors 54 may optionally include one or more cameras. The position and motion sensors may track a user's head pose by directly determining any movement, yaw, pitch, roll, etc. for head-mounted device 10. The yaw, roll, and pitch of the user's head may collectively define a user's head pose.

Gaze detection sensors 80, sometimes referred to as a gaze tracker, may be configured to gather gaze information or point of gaze information. The gaze tracker may employ one or more inward facing camera(s) (e.g., cameras 42) and/or other gaze-tracking components (e.g., eye-facing components and/or other light sources such as light sources 44 that emit beams of light so that reflections of the beams from a user's eyes may be detected) to monitor the user's eyes. One or more gaze-tracking sensor(s) may face a user's eyes and may track a user's gaze. A camera in gaze-tracking subsystem may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze tracker may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze.

Hand tracking sensor(s) 82, sometimes referred to as a hands tracker or hand tracking subsystem, may be configured to monitor a user's hand motion/gesture to obtain hand gestures data. For example, the hands tracker may include a camera and/or other gestures tracking components (e.g., outward facing components and/or light sources that emit beams of light so that reflections of the beams from a user's hand may be detected) to monitor the user's hand(s). One or more hands-tracking sensor(s) 82 may be directed towards a user's hands and may track the motion associated with the user's hand(s), may determine whether the user is performing a swiping motion with his/her hand(s), may determine whether the user is performing a non-contact button press or object selection operation with his/her hand(s), may determine whether the user is performing a grabbing or gripping motion with his/her hand(s), may determine whether the user is pointing at a given object that is presented on display 14 using his/her hand(s) or fingers, may determine whether the user is performing a waving or bumping motion with his/her hand(s), or may generally measure/monitor three-dimensional non-contact gestures (“air gestures”) associated with the user's hand(s).

The virtual content generated by graphics rendering pipeline 56 and the user tracking information (e.g., head tracking information, gaze tracking information, hand tracking information, and information associated with other user body parts) output from user tracking sensors 54, 80, and 82 may be provided to virtual content compositor 58. Based on content and information from multiple data sources, virtual content compositor 58 may generate corresponding composited virtual frames. The virtual content compositor 58 may perform a variety of compositor functions that adjust the virtual content based on the user tracking information to help improve the image quality of the final content that will be displayed to the user. The adjustments to virtual content may be performed by virtual content compositor 58 and/or media merging compositor 60.

For example, virtual content compositor 58 may perform image warping operations to reproject the virtual content from one user perspective to another, lens distortion compensation operations to fix issues associated with the distortion that might be caused by lens(es) 30 in front of display 14, brightness adjustments, color shifting, chromatic aberration correction, optical crosstalk mitigation operations, and/or other optical correction processes to enhance the apparent quality of the composited virtual frames.

The decisions made by the virtual content compositor 58 or other display control functions to generate each composited virtual frame may be listed in one or more virtual content compositor parameters. The parameters may include color adjustment parameters 88, brightness adjustment parameters 90, distortion parameters 92, and any other desired parameters used to adjust the virtual content.

The human eye perceives color differently depending on the current viewing condition. For example, the chromatic or color adaptation behavior of the human visual system may vary based on whether the current viewing state is an immersive viewing condition (e.g., viewing displays on head-mounted device 10 through lenses 30) or other non-immersive viewing conditions (e.g., viewing a non-stereoscopic display on a cellular telephone, tablet computer, or laptop computer). In accordance with an embodiment, device 10 may be operated using a chromatic (color) adaptation model configured to mimic the behavior of the human vision system (i.e., the human eye) such that the perceived color of the virtual content output by displays 14 matches the perceived color of the same virtual content if the user were to view the same content without wearing device 10. In other words, device 10 may be provided with a color adaptation model that corrects/adjusts the virtual content in a way such that the resulting corrected color of the virtual content perceived by the user under an immersive viewing condition matches the color perceived by the user if the user were to view the same scene or content under a non-immersive viewing condition (e.g., if the user were to view the same content on a non-head-mounted device). The color adjustments applied to the virtual content by virtual content compositor 58 may be represented by color adjustment parameters 88 and may sometimes be referred to as a color adaptation matrix or chromatic adaptation matrix. The color adjustment parameters 88 may include color adjustment parameters as well as tone mapping parameters.

In some cases, the virtual content may be selectively dimmed by virtual content compositor 58 (e.g., for a vignetting scheme in which the periphery of the display is dimmed to improve the aesthetic appearance of the display). The brightness adjustment parameters 90 may represent dimming applied by the virtual content compositor.

Virtual content compositor 58 may perform image warping operations to reproject the virtual content from one user perspective to another and/or may perform lens distortion compensation operations to fix issues associated with the distortion that might be caused by lens(es) 30 in front of display 14. The warping and/or distortion correction applied by virtual content compositor 58 is represented by distortion parameters 92.

The image correction or adjustment may be applied at virtual content compositor 58 or some other component such as media merging compositor 60. In embodiments where the image correction/adjustment is performed at media merging compositor 60, virtual content compositor 58 may send a mesh that includes corrections based on gaze parameter(s), head pose parameter(s), hand gesture parameter(s), image warping parameter(s), foveation parameter(s), brightness adjustment parameter(s), color adjustment parameter(s), chromatic aberration correction parameter(s), point of view correction parameter(s), and/or other parameters to media merging compositor 60.

Operated in this way, virtual content compositor 58 may relay its image correction decisions to media merging compositor 60, and media merging compositor 60 may then execute those decisions on the virtual frames and/or the passthrough feed and subsequently perform the desired merging or blending of the corrected video frames.

The composited virtual frames may be merged with a live video feed captured by one or more image sensor(s) 50 prior to being output at display 14. Image sensors 50 may include one or more front-facing camera(s) and/or other cameras used to capture images of the external real-world environment surrounding device 10. A video feed output from camera(s) 50 may sometimes be referred to as the raw video feed or a live passthrough video stream. Image sensor(s) 50 may provide both the passthrough feed and image sensor metadata to image signal processor 52. The image sensor metadata output by image sensor(s) 50 may include operation settings and/or fixed characteristics for the image sensor(s) 50 such as exposure times, aperture settings, white balance settings, etc.

The passthrough feed output from camera(s) 50 may be processed by image signal processor (ISP) 52 configured to perform image signal processing functions. For example, ISP block 52 may be configured to perform automatic exposure for controlling an exposure setting for the passthrough video feed, automatic color correction (sometimes referred to as automatic white balance) for controlling a white balance, tone curve mapping, gamma correction, shading correction, noise reduction, black level adjustment, demosaicing, image sharpening, high dynamic range (HDR) correction, color space conversion, and/or other image signal processing functions (just to name a few) to output corresponding processed video frames. The image signal processing functions performed by ISP 52 may optionally be based on gaze tracking information from gaze detection sensor(s) 80, information regarding the virtual content output by graphics rendering pipeline 56, and/or other information within electronic device 10. For example, ISP 52 may adjust the passthrough feed based on gaze tracking information (e.g., for a foveated display), may adjust the passthrough feed to better match virtual content, etc.

The image signal processor may apply parameters such as color adjustment parameters 94, brightness adjustment parameters 96, and distortion parameters 98 when adjusting the passthrough feed.

Color adjustment parameters 94 (sometimes referred to as a color adaptation matrix or chromatic adaptation matrix) may correct/adjust the passthrough video feed such that the resulting corrected color of the passthrough video feed perceived by the user under immersive viewing conditions matches the color perceived by the user if the user were to view the same scene or content under a non-immersive viewing condition (e.g., if the user were to view the same scene while not wearing a head-mounted device or if the user were to view the same captured content on a non-head-mounted device). The color adjustment parameters 94 may include color adjustment parameters as well as tone mapping parameters.

In some cases, the passthrough feed may be selectively dimmed by ISP 52 (e.g., for a vignetting scheme in which the periphery of the display is dimmed to improve the aesthetic appearance of the display). The brightness adjustment parameters 96 may represent dimming applied by the ISP.

ISP 52 may perform image warping operations to reproject the passthrough feed from one user perspective to another and/or may perform lens distortion compensation operations to fix issues associated with the distortion that might be caused by lens(es) 30 in front of display 14. The warping and/or distortion correction applied by ISP 52 is represented by distortion parameters 98.

Media merging compositor 60 may receive the processed video frames output from image signal processor 52, may receive the composited virtual frames output from virtual content compositor 58, and may overlay or otherwise combine one or more portions of the composited virtual frames with the processed video frames to obtain corresponding merged video frames. The merged video frames output from the media merging compositor 60 may then be presented on display 14 to be viewed by the user of device 10. If desired, the passthrough feed may be foveated by image signal processor 52 and/or media merging compositor 60 using gaze tracking information from gaze detection sensor(s) 82. The foveation scheme applied to the virtual content (e.g., by graphics rendering pipeline 56) may optionally be different than the foveation scheme applied to the passthrough feed (e.g., by image signal processor 52 and/or media merging compositor 60).

Media merging compositor 60 may perform video matting operations. The video matting operations may determine whether each portion of the presented content shows the composited virtual content or the live passthrough content. In certain scenarios, the video matting operations might decide to show more of the live passthrough content when doing so would enhance the safety of the user (e.g., such as when a user might be moving towards an obstacle). In other scenarios, the video matting operations might decide to show less of the live passthrough content (e.g., to prevent a user's hands from blocking virtual content). In other words, media merging compositor 60 may provide information on what parts of a secondary image stream (e.g., the camera feed tracking hands) need to be cropped out of the secondary stream when composted into the final scene. Video matting applied to images of the user's hands may be referred to as hands matting operations. Media merging compositor 60 may optionally receive hand tracking information that is used for hands matting operations.

In general, the adjustment parameters described herein (e.g., color adjustment parameters, brightness adjustment parameters, distortion parameters, etc.) may be implemented separately on virtual content and passthrough content. These adjustments before the virtual content has been blended with the passthrough feed may be referred to as pre-blend adjustments. Instead or in addition to pre-blend adjustments, the electronic device may implement one or more adjustment parameters subsequent to blending the virtual content and passthrough content at media merging compositor 60. These adjustments after the virtual content has been blended with the passthrough feed may be referred to as post-blend adjustments.

While the merged video frames are provided to and presented on display 14, one or more sound generating subsystems 84 may provide audio data to be played on one or more speakers 86. The one or more sound generating subsystems 84 may include an operating system for the electronic device, an application running on the electronic device, etc.

To provide device 10 with recording capabilities, device 10 may include a separate recording subsystem such as recording pipeline 68. As shown in FIG. 3, recording pipeline 68 may include a recorder processing block 72 and recorder memory 74. To provide flexibility in subsequent editing and replay of a recording, the recording pipeline may record a wide variety of information associated with an extended reality experience. In general, any of the intermediate parameters, metadata, raw content, and adjusted content in FIG. 3 may be recorded by recording pipeline 68.

As shown in FIG. 3, the virtual content output by graphics rendering pipeline 56 may be provided to and recorded by recording pipeline 68. The recording pipeline may record the virtual content as a single layer or as multiple layers.

The head tracking information, gaze tracking information, and hand tracking information that is provided to the virtual content compositor may also be provided to and recorded by recording pipeline 68.

Virtual content compositor parameters used by virtual content compositor 58 and/or media merging compositor 60 may be provided to and recorded by recording pipeline 68. The virtual content compositor parameters may include color adjustment parameters 88, brightness adjustment parameters 90, and distortion parameters 92. Instead or in addition, the virtual content compositor parameters may include which input frame(s) are used from the virtual content, a foveation parameter used in performing the dynamic foveation, an identification of a subset of the head, gaze, and/or hand tracking information that is used in a given frame, etc.

In addition to being provided to media merging compositor 60, the output of the virtual content compositor may be provided to and recorded by the recording pipeline.

In addition to being provided to image signal processor 52, the passthrough feed and image sensor metadata from image sensor(s) 50 may be provided to and recorded by the recording pipeline.

ISP parameters used by ISP 52 may be provided to and recorded by recording pipeline 68. The ISP parameters may include color adjustment parameters 94 (e.g., a color adaptation matrix), brightness adjustment parameters 96, distortion parameters 98, and any other parameters used in adjusting the passthrough feed.

In addition to being provided to display(s) 14, the output of media merging compositor 60 may be provided to and recorded by the recording pipeline. Similarly, compositing metadata associated with the compositing of the passthrough feed and the virtual content may be provided to and recorded by recording pipeline 68. The compositing metadata used and output by media merging compositor 60 may include information on how the virtual content and passthrough feed are blended together (e.g., one or more alpha values), information on video matting operations, etc.

In addition to being provided to speaker(s) 86, the audio data may be provided to and recorded by the recording pipeline 68.

Recording pipeline 68 may receive and record various information from the system associated with the extended reality session. The information may be stored in memory 74. Before or after recording the information, recording processor 72 may optionally perform additional operations such as selecting a subset of the received frames for recording (e.g., selecting alternating frames to be recorded, selecting one out of every three frames to be recorded, selecting one out of every four frames to be recorded, selecting one out of every five to ten frames for recording, etc.), limiting the rendered frames to a smaller field of view (e.g., limiting the X dimension of the rendered content, limiting the Y dimension of the rendered content, or otherwise constraining the size or scope of the frames to be recorded), undistorting the rendered content since the content being recorded might not be viewed through a lens during later playback, etc.

In another embodiment, processor 72 may perform video matting operations before recording content. For example, the video matting operations might intentionally obscure or blur a portion of the content (e.g., such as when a user inputs a password or other sensitive information on the display screen, and the sensitive information may be obfuscated in the recording).

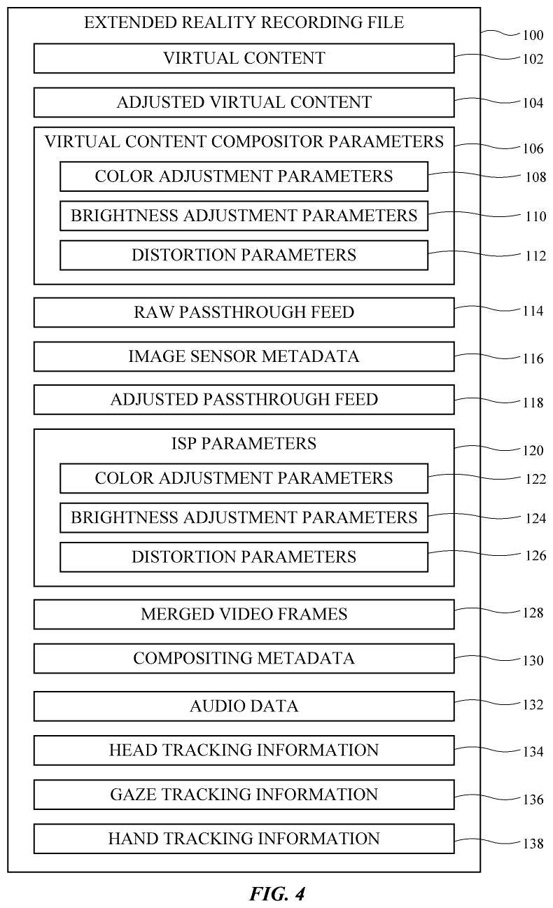

Recording pipeline 68 ultimately stores the extended reality recording in memory 74 (e.g., as a file). An illustrative file stored by the recording pipeline is shown in FIG. 4. As shown, the file may have a plurality of discrete tracks (sometimes referred to as plates, subsets, portions, etc.). As shown in FIG. 4, the tracks may include a virtual content track 102 (including the virtual content output by graphics rendering pipeline 56), an adjusted virtual content track 104 (including the adjusted virtual content output by virtual content compositor 58), one or more virtual content compositor parameter tracks 106 such as a color adjustment parameter track 108 (including the color adjustment parameters 88 used by virtual content compositor 58), brightness adjustment parameter track 110 (including the brightness adjustment parameters 90 used by virtual content compositor 58), and distortion parameter track 112 (including the distortion adjustment parameters 92 used by virtual content compositor 58), a raw passthrough feed track 114 (including the passthrough feed output by image sensor(s) 50 and before processing by ISP 52), an image sensor metadata track 116 (including the image sensor metadata output by image sensor(s) 50), an adjusted passthrough feed track 118 (including the adjusted passthrough feed output by ISP 52), one or more ISP parameter tracks 120 such as a color adjustment parameter track 122 (including the color adjustment parameters 94 used by ISP 52), brightness adjustment parameter track 124 (including the brightness adjustment parameters 96 used by ISP 52), and distortion parameter track 126 (including the distortion adjustment parameters 98 used by ISP 52), a merged video frame track 128 (including the merged video frames output by media merging compositor 60), a compositing metadata track 130 (including the compositing metadata associated with media merging compositor 60), an audio data track 132 (including the audio data provided to speakers 86 by sound generating subsystems 84), a head tracking information track 134 (including data from one or more position and motion sensors 54), a gaze tracking information track 136 (including data from one or more gaze detection sensors 80), and a hand tracking information track 138 (including data from one or more hand tracking sensors 82).

The example of FIG. 4 is merely illustrative. In general, one or more of the tracks in FIG. 4 (e.g., the merged video frame track 128, the adjusted passthrough feed track 118, the adjusted virtual content track 104, etc.) may optionally be omitted from the extended reality recording file.

Storing discrete tracks associated with the extended reality experience as in FIG. 4 may allow for discrete components of the extended reality experience to be edited individually. The discrete components may then be used to present a replay of the extended reality experience using the edited extended reality recording file. The replay (with edits) may be presented on a stereoscopic display (e.g., an immersive display) or a non-stereoscopic display (e.g., a non-immersive display).

Graphics rendering pipeline 56, virtual content compositor 58, media merging compositor 60, image signal processor 52, recording pipeline 68, recording compositor 200, and editing tools 202 may be considered part of control circuitry 20 in electronic device 10.

As shown in FIG. 3, head-mounted device 10 may further include a recording compositor 200. The recording compositor may present a replay of an extended reality session using an extended reality recording file stored in memory 74 of recording pipeline 68. The recording compositor may include a virtual content compositor (similar to virtual compositor 58), an image signal processor (similar to image signal processor 52), and/or a media merging compositor (similar to media merging compositor 60) that are used to present an extended reality environment using display(s) 14 and/or speaker(s) 86 based on the extended reality recording file. Instead or in addition, the recording compositor may provide information to virtual compositor 58, image signal processor 52, and/or media merging compositor 60 to present an extended reality environment using display(s) 14 and/or speaker(s) 86 based on the extended reality recording file. Said another way, recording compositor 200 may have discrete resources that are separate from the resources used to present the extended reality environment in real time and/or may share the resources that are used to present the extended reality environment in real time.

Head-mounted device 10 may further include one or more editing tools 202 that are used to edit the extended reality recording file(s) generated by recording pipeline 68. The editing tools 202 may include applications and/or operating system functions that enable one or more portions of the extended reality recording file to be edited. The editing tools may be used to edit any individual track in the extended reality recording file without impacting the other tracks in the extended reality recording file.

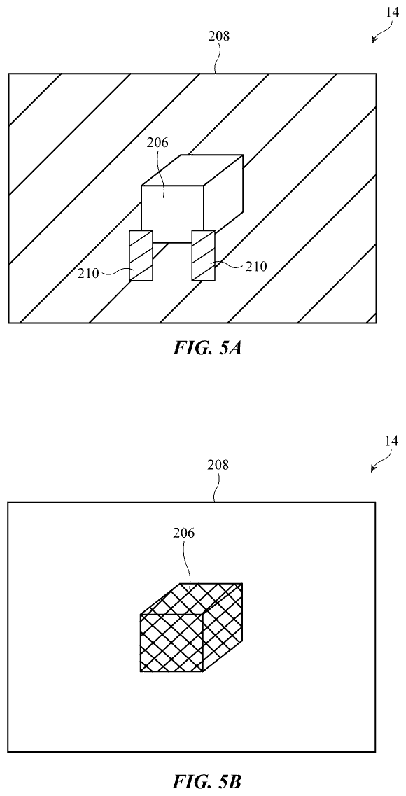

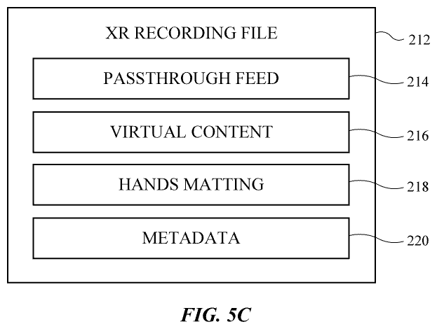

As an example, during real time presentation of an extended reality environment a raw passthrough feed may be adjusted using a first color adaptation matrix (e.g., color adjustment parameters 94) and virtual content may be adjusted using color adjustment parameters 88. The resulting images presented to the viewer are shown in FIG. 5A. As shown, virtual content 206 having a first color is presented over a passthrough video feed 208 having a second color.

FIG. 5A also shows how the user's hands 210 may be visible over virtual content 206. Hands matting operations may be performed during real time presentation of the extended reality environment to ensure that hands 210 are visible (e.g., so that hands 210 block virtual content 206 instead of virtual content 206 blocking hands 210).

FIG. 5C shows an XR recording file 212 associated with the real time presentation of the extended reality environment shown in FIG. 5A. As shown in FIG. 5C, the XR recording file includes various decomposed layers such as the passthrough feed 214, virtual content 216, hands matting 218, and metadata 220. Metadata 220 may include, as an example, color adjustment parameters such as color adjustment parameters 88 and/or 94 from FIG. 3.

The extended reality recording file of FIG. 5C may subsequently be edited (e.g., by editing tools 202) to change the color adjustments applied to the raw passthrough feed and/or the virtual content, to change the hands matting applied to the content, etc.

The edited extended reality recording file may be used by recording compositor 200 to present the edited version of the extended reality environment. For example, the recording compositor may direct the unedited passthrough feed and the edited color adaptation matrix to image signal processor 52. The image signal processor adjusts the passthrough feed according to the edited color adaptation matrix and the adjusted passthrough feed is subsequently presented to the viewer. The recording compositor also directs the unedited virtual content and edited color adjustment parameters 88 to virtual content compositor 58. The virtual content compositor adjusts the virtual content according to the edited color adjustment parameters and the adjusted virtual content is subsequently presented to the viewer.

The edited replay of the extended reality environment is shown in FIG. 5B. As shown in FIG. 5B, the color of virtual content 206 has changed in FIG. 5B relative to FIG. 5A. Similarly, the color of passthrough video feed 208 has changed in FIG. 5B relative to FIG. 5A.

The replay of FIG. 5B is also edited to remove hands 210, allowing all of virtual content 206 to be visible in the edited replay shown in FIG. 5B.

Storing the decomposed layers in XR recording file 212 therefore enables playback to decide how to combine passthrough and virtual content. The combination of passthrough and virtual content may be different when the replay is presented (as in FIG. 5B) than during the real time presentation (as in FIG. 5A). Changes that may be made when combining passthrough and virtual content for the replay may include emphasizing color/brightness of virtual content, replacing passthrough content with another background (or vice versa), changing the viewer perspective, adjusting transparency of content, adjusting relative depth of content, etc.

Again considering the example of FIG. 5A, the real time extended reality environment presented by electronic device 10 may be missing some information (e.g., some of background 208 is blocked by virtual content 206 and/or hands 210 and some of virtual content 206 is blocked by hands 210). If only the presented environment of FIG. 5A was recorded, the missing information would not be recoverable. However, when the presented environment is recorded using decomposed layers as in FIG. 5C, the missing information from the real time presentation is part of the XR recording file and may therefore be used in subsequent replays of the XR environment if desired. For example, the XR recording file includes data for the portion of the passthrough feed that is blocked by virtual content 206 in FIG. 5A. In a replay, the virtual content 206 may be omitted so that this portion of the passthrough feed is visible. As another example, the XR recording file includes data for the portion of the virtual content that is blocked by hands 210 in FIG. 5A. In a replay, the hands 210 may be omitted so that this portion of the virtual content is visible.

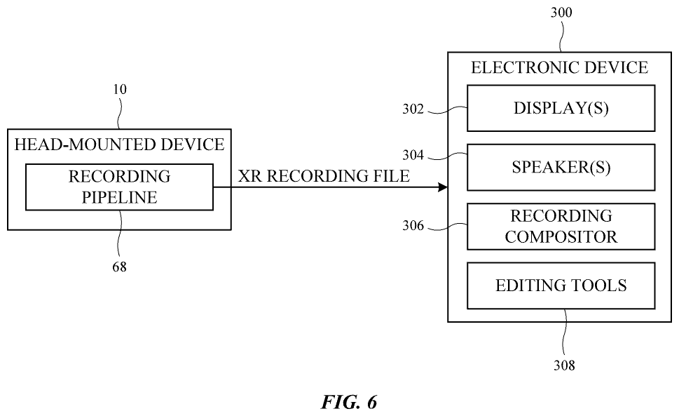

As shown in FIG. 6, an XR recording file from recording pipeline 68 in head-mounted device 10 may be exported to an additional electronic device 300. Electronic device 300 may be a cellular telephone, a computer such as a tablet computer or laptop computer, a server, or any other desired type of electronic device. The file may be exported using wired or wireless communication. Electronic device 300 may have one or more input-output devices configured to present an XR environment such as display(s) 302 and speaker(s) 304. In general, electronic device 300 may include any of the components already described in connection with electronic device 10. Electronic device 300 may have communication circuitry sharing any of the features described in connection with communication circuitry 22 of FIG. 2 and configured to receive the XR recording file from electronic device 10.

FIG. 6 shows how electronic device 300 may include a recording compositor 306 (similar to recording compositor 200 in FIG. 3) and editing tools 308 (similar to editing tools 202 in FIG. 3). Editing tools 308 may be capable of editing any discrete track in the received XR recording file. In this way, the editing tools may edit a specific component of the XR session without impacting the other components of the XR session. Recording compositor 306 may be able to use the XR recording file (before or after editing) to present a replay of the XR session represented by the XR recording file.

Recording compositor 306 and/or editing tools may automatically edit one or more portions of the XR recording file to make the replay of the XR session suitable for the display 302 in electronic device 300 (e.g., adjusting the XR recording file for a non-immersive display). These edits may also be performed manually by a user using editing tools 308.

Recording compositor 306 and editing tools 308 may be considered part of the control circuitry in electronic device 300. The control circuitry in electronic device 300 may share any of the features described in connection with control circuitry 20 of FIG. 2.

The arrangement of FIG. 3 may allow for data to be captured at different rates and adjusted as needed during subsequent processing. For example, head-mounted device 10 may operate display 14 at a higher frame rate than display 302 in electronic device 300. The capture and post processing chain (e.g., as shown in FIG. 3) may allow for different frame rates to be captured as needed. The frame rates may also be adjusted during subsequent processing (e.g., for replay on a different device).

As an example, display 14 in head-mounted device 10 may operate using a first frame rate. The display frames for display 14 may be recorded by recording pipeline 68 at the first frame rate. The display frames may be timestamped (e.g., identifying the frame rate) or other metadata identifying the frame rate may be recorded at recording pipeline 68. The XR recording file may transmit the XR recording file to electronic device 300 (as in FIG. 6). Electronic device 300 may operate display 302 at a second frame rate that is lower than the first rate. The recording compositor 306 and/or editing tools 308 in electronic device 300 may adjust the display frames that are recorded at the first frame rate in order to present the display frames at the second frame rate (e.g., by dropping some of the recorded frames or using other desired adjustments).

Other data in the XR recording file may have a recording rate that is asynchronous with the first frame rate for the display frames. For example, the passthrough feed may have a third frame rate that is different than the first frame rate. In general, each type of data recorded by recording pipeline 68 may have any desired frame rate and these frame rates may be adjusted as desired during subsequent replays using the XR recording file.

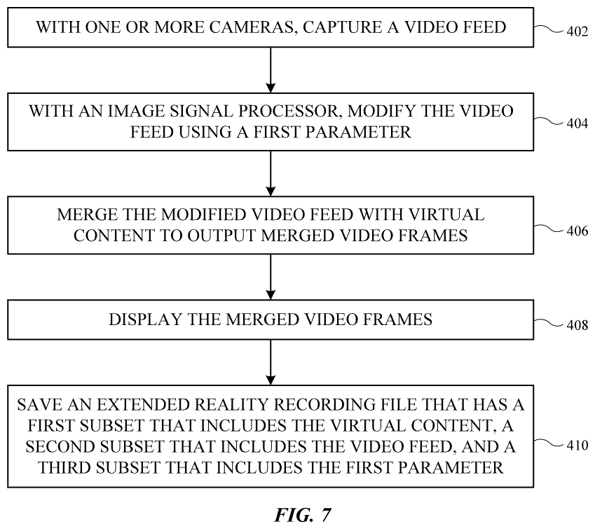

FIG. 7 is a flowchart showing an illustrative method performed by an electronic device (e.g., control circuitry 20 in device 10). The blocks of FIG. 7 may be stored as instructions in memory of electronic device 10, with the instructions configured to be executed by one or more processors in the electronic device.

During the operations of block 402, a video feed (e.g., a passthrough video feed) may be captured with one or more cameras such as image sensor(s) 50 in FIG. 3. Image sensors 50 may include, for example, the forward-facing cameras 46 in FIG. 1. The cameras may capture a video feed of the user's physical environment (e.g., images of the physical environment from the perspective of the user if the user was not wearing the head-mounted device).

During the operations of block 404, the video feed may be modified by an image signal processor using a first parameter. As shown in FIG. 3, image signal processor 52 may have parameters such as color adjustment parameters 94, brightness adjustment parameters 96, and distortion parameters 98. At least one of these parameters may be used to modify the video feed received from image sensors 50 and output a modified video feed.

During the operations of block 406, the modified video feed may be merged with virtual content (e.g., virtual content from virtual content compositor 58) to output merged video frames. The modified video feed may be merged with virtual content by media merging compositor 60, as one example.

During the operations of block 408, the merged video frames may be displayed (e.g., on display(s) 14).

During the operations of block 410, an extended reality recording file may be saved that represents the extended reality session during which the merged video frames are displayed. The XR recording file may have a plurality of subsets (as shown by the discrete tracks in FIG. 4). A first subset (e.g., virtual content track 102 and/or adjusted virtual content track 104) may include the virtual content, a second subset (e.g., raw passthrough feed track 114) may include the video feed, and a third subset (e.g., color adjustment parameter track 122, brightness adjustment parameter track 124, and/or distortion parameter track 126) may include the first parameter used during the operations of block 404.

The extended realty recording file saved during the operations of block 410 may include one or more additional subsets. The one or more additional subsets may include any of the tracks shown in FIG. 4: virtual content compositor parameter tracks 106 such as a color adjustment parameter track 108 (including the color adjustment parameters 88 used by virtual content compositor 58), brightness adjustment parameter track 110 (including the brightness adjustment parameters 90 used by virtual content compositor 58), and distortion parameter track 112 (including the distortion adjustment parameters 92 used by virtual content compositor 58), an image sensor metadata track 116 (including the image sensor metadata), an adjusted passthrough feed track 118 (including the passthrough feed track output by ISP 52), a merged video frame track 128 (including the merged video frames output by media merging compositor 60), a compositing metadata track 130 (including the compositing metadata associated with media merging compositor 60), an audio data track 132 (including the audio data provided to speakers 86 by sound generating subsystems 84), a head tracking information track 134 (including data from one or more position and motion sensors 54), a gaze tracking information track 136 (including data from one or more gaze detection sensors 80), and/or a hand tracking information track 138 (including data from one or more hand tracking sensors 82).

The extended reality recording file 100 may subsequently be used to present a replay of the extended reality session on head-mounted device 10. Any component of the extended reality recording file may optionally be edited before the replay is presented on head-mounted device 10. Edits to a given track in the extended reality recording file may not impact the other tracks in the extended reality recording file. Subsequently, the replay may be presented (e.g., using recording compositor 200) using the edited track such that the edit is propagated to the replay that is presented using display(s) 14 and/or speaker(s) 86.

The extended reality recording file may also optionally be exported to an additional electronic device (e.g., electronic device 300 in FIG. 6) using communication circuitry 22. The communication circuitry may send the file to the additional electronic device using wired or wireless communication. The additional electronic device may edit the extended reality recording file (e.g., to fit a non-stereoscopic display) and subsequently present the replay of the extended reality session using the edited extended reality recording file.

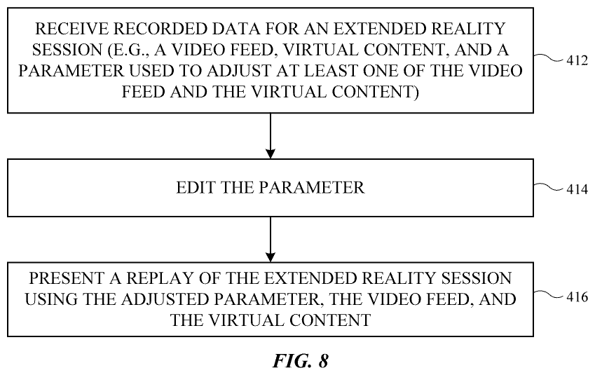

FIG. 8 is a flowchart showing an illustrative method performed by an electronic device (e.g., control circuitry in device 300). The blocks of FIG. 8 may be stored as instructions in memory of electronic device 300, with the instructions configured to be executed by one or more processors in the electronic device.

During the operations of block 412, the electronic device may receive (e.g., via wired or wireless communication) recorded data (e.g., an extended reality recording file) for an extended reality session. The extended reality session may have occurred in real time on a different electronic device. The recorded data may include a video feed (e.g., a passthrough video feed as in raw passthrough feed track 114 and/or adjusted passthrough feed track 118), virtual content (e.g., virtual content track 102 and/or adjusted virtual content track 104), and/or a parameter used to adjust at least one of the video feed and the virtual content (e.g., color adjustment parameter track 108, brightness adjustment parameter track 110 distortion parameter track 112, color adjustment parameter track 122, brightness adjustment parameter track 124, distortion parameter track 126, and/or compositing metadata track 130).

The received data at block 412 may include any of the additional tracks shown in XR recording file 100 of FIG. 4.

During the operations of block 414, the parameter may be edited (e.g., by editing tools 308). Then, during the operations of block 416, electronic device 300 may present a replay of the extended reality session using the adjusted parameter from block 414, the unedited video feed, and the unedited virtual content.

Consider an example where a first color adaptation matrix is applied to the passthrough feed by ISP 52 during real time presentation of an extended reality environment by head-mounted device 10. The head-mounted device 10 may save an XR recording file with a raw passthrough feed track 114 (containing the raw passthrough data before adjustment using the color adaptation matrix), virtual content track 102 (containing the virtual content), and color adjustment parameter track 124 (containing the first color adaptation matrix that is used to modify the passthrough video for head-mounted device 10). During the operations of block 412, electronic device 300 receives the XR recording file from electronic device 10. The received XR recording file 100 has a color adjustment parameter track 124 that includes the first color adaptation matrix. During the operations of block 414, the color adjustment parameter track 124 may be edited to instead include a second color adaptation matrix that is different than the first color adaptation matrix. The second color adaptation matrix may be designed for the non-immersive display of electronic device 300 whereas the first color adaptation matrix may be designed for the immersive display of electronic device 10. Finally, during the operations of block 416, the replay of the extended reality session is presented using the second color adaptation matrix to modify the passthrough video feed instead of the first color adaptation matrix.

As another example, a different tone mapping function may be used during the operations of block 416 than during the operations of block 412.

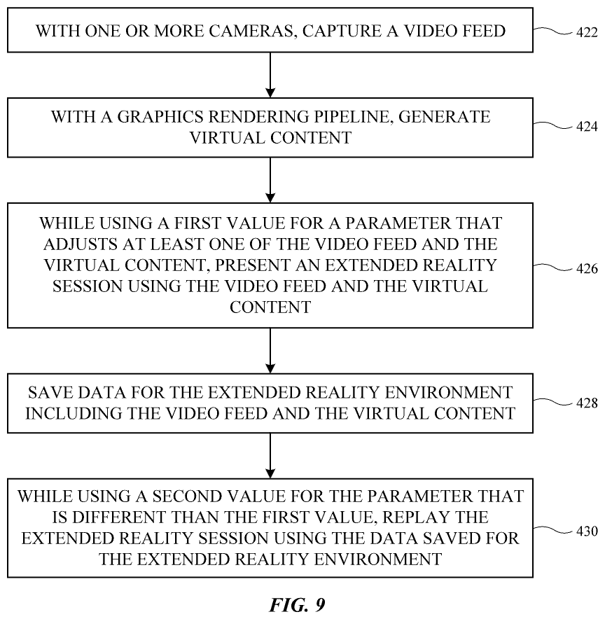

FIG. 9 is a flowchart showing an illustrative method performed by an electronic device (e.g., control circuitry 20 in device 10). The blocks of FIG. 9 may be stored as instructions in memory of electronic device 10, with the instructions configured to be executed by one or more processors in the electronic device.

During the operations of block 422, a video feed (e.g., a passthrough video feed) may be captured with one or more cameras such as image sensor(s) 50 in FIG. 3. Image sensors 50 may include, for example, the forward-facing cameras 46 in FIG. 1. The cameras may capture a video feed of the user's physical environment (e.g., images of the physical environment from the perspective of the user if the user was not wearing the head-mounted device).

During the operations of block 424, a graphics rendering pipeline may generate virtual content. The graphics rendering pipeline (e.g., graphics rendering pipeline 56 in FIG. 3) may synthesize photorealistic or non-photorealistic images from one or more 2-dimensional or 3-dimensional model(s) defined in a scene file that contains information on how to simulate a variety of features such as information on shading (e.g., how color and brightness of a surface varies with lighting), shadows (e.g., how to cast shadows across an object), texture mapping (e.g., how to apply detail to surfaces), reflection, transparency or opacity (e.g., how light is transmitted through a solid object), translucency (e.g., how light is scattered through a solid object), refraction and diffraction, depth of field (e.g., how certain objects may appear out of focus when outside the depth of view), motion blur (e.g., how certain objects may appear blurry due to fast motion), and/or other visible features relating to the lighting or physical characteristics of objects in a scene. The graphics rendering pipeline may apply rendering algorithms such as rasterization, ray casting, ray tracing, radiosity, or other graphics processing algorithms.

During the operations of block 426, the electronic device may present an extended reality session using the video feed from block 422 and the virtual content from block 424. The extended reality session may be presented while using a first value for a parameter that adjusts at least one of the video feed and the virtual content. The parameter may include, for example, color adjustment parameters 88, brightness adjustment parameters 90, distortion parameters 92, color adjustment parameters 94, brightness adjustment parameters 96, distortion parameters 98, a composite parameter (e.g., used to blend the video feed and the virtual content by media merging compositor 60), etc.

During the operations of block 428, electronic device 10 may save data for the extended reality environment including the video feed and the virtual content. The data may be saved in an extended reality recording file as shown in FIG. 4, as one example.

During the operations of block 430, the electronic device may present an extended reality session using the saved video feed and the saved virtual content from block 428. However, the replay may be presented while using a second value for the parameter that is different than the first value. In other words, at least one of the color adjustment parameters 88, brightness adjustment parameters 90, distortion parameters 92, color adjustment parameters 94, brightness adjustment parameters 96, distortion parameters 98, and a composite parameter is different when the saved video feed and virtual content are replayed using electronic device 10 than when the video feed and virtual content were presented in real time using electronic device 10.

The foregoing is merely illustrative and various modifications can be made to the described embodiments. The foregoing embodiments may be implemented individually or in any combination.

What is claimed is:

1. A method of operating an electronic device to display a mixed reality scene, comprising:
with at least one image sensor, capturing video frames;
rendering virtual content;
displaying the mixed reality scene by generating display frames based on the captured video frames, the rendered virtual content, and at least one parameter; and
generating a recording of the mixed reality scene comprised of:
a first track including the captured video frames;
a second track including the rendered virtual content; and
metadata including the at least one parameter.

2. The method defined in claim 1, wherein displaying the mixed reality scene by generating display frames based on the captured video frames, the rendered virtual content, and at least one parameter comprises:
with an image signal processor, modifying the captured video frames using a first parameter of the at least one parameter.

3. The method defined in claim 1, further comprising:
while displaying the mixed reality scene, playing audio data using a speaker, wherein the recording has a third track that includes the audio data played using the speaker.

4. The method defined in claim 1, further comprising:
a sensor configured to obtain head tracking information, wherein the recording has a third track that includes the head tracking information.

5. The method defined in claim 1, further comprising:
a sensor configured to obtain gaze tracking information, wherein the recording has a third track that includes the gaze tracking information.

6. The method defined in claim 1, further comprising:
a sensor configured to obtain hand tracking information, wherein the recording has a third track that includes the hand tracking information.

7. The method defined in claim 1, wherein displaying the mixed reality scene by generating display frames based on the captured video frames, the rendered virtual content, and at least one parameter comprises merging the captured video frames with the rendered virtual content to generate the display frames.

8. The method defined in claim 7, wherein displaying the mixed reality scene by generating display frames based on the captured video frames, the rendered virtual content, and at least one parameter further comprises, before merging the captured video frames with the rendered virtual content to generate the display frames:
adjusting the rendered virtual content using a first parameter of the at least one parameter.

9. The method defined in claim 7, wherein displaying the mixed reality scene by generating display frames based on the captured video frames, the rendered virtual content, and at least one parameter further comprises, before merging the captured video frames with the rendered virtual content to generate the display frames:
adjusting the captured video frames using a first parameter of the at least one parameter.

10. The method defined in claim 7, wherein displaying the mixed reality scene by generating display frames based on the captured video frames, the rendered virtual content, and at least one parameter further comprises, after merging the captured video frames with the rendered virtual content to generate the display frames:
adjusting the display frames using a first parameter of the at least one parameter.

11. The method defined in claim 1, wherein the metadata further comprises metadata associated with the at least one image sensor.

12. The method defined in claim 1, wherein the at least one parameter comprises a color adaptation matrix.

13. The method defined in claim 1, wherein the at least one parameter comprises a brightness adjustment parameter.

14. The method defined in claim 1, wherein the at least one parameter comprises a distortion parameter.

15. A method of operating an electronic device, comprising:
receiving recorded data for an extended reality session, wherein the recorded data comprises a video feed, virtual content, and a parameter used to adjust at least one of the video feed and the virtual content;
editing the parameter; and
presenting a replay of the extended reality session using the edited parameter, the video feed, and the virtual content.

16. The method defined in claim 15, wherein receiving the recorded data comprises receiving an extended reality recording file from a head-mounted device.

17. The method defined in claim 15, wherein the parameter comprises a color adjustment parameter for the video feed.

18. The method defined in claim 15, wherein the parameter comprises a distortion parameter for the video feed.

19. The method defined in claim 15, wherein parameter comprises a compositing parameter that is used to blend the video feed and the virtual content into merged video frames.

20. A method of operating an electronic device, comprising:
with one or more cameras, capturing a video feed;
with a graphics rendering pipeline, generating virtual content;
while using a first value for a parameter that adjusts at least one of the video feed and the virtual content, presenting an extended reality session using the video feed and the virtual content;
saving data for the extended reality session including the video feed and the virtual content; and
while using a second value for the parameter that is different than the first value, replaying the extended reality session using the data saved for the extended reality environment.
